(19) United States
(12) Patent Application Publication
(10) Pub. No.: US 2021/0211456 A1
(43) Pub. Date: Jul. 8, 2021

(54) DEVICE, METHOD AND NON-TRANSITORY TANGIBLE MACHINE-READABLE MEDIUM FOR TESTING A CYBER DEFENSE MECHANISM OF A DEVICE UNDER TEST

(71) Applicant: Institute For Information Industry, Taipei (TW)

(72) Inventors: Yu-Ding HUANG, Taipei (TW); Shu-Min CHUANG, Taipei (TW); Chia-Che CHANG, Taipei (TW); En-Sih LIOU, Taipei (TW)

(21) Appl. No.: 16/747,481

(22) Filed: Jan. 20, 2020

(30) Foreign Application Priority Data
Jan. 2, 2020 (TW) 109100076

(51) Int. Cl. H04L 29/06

(52) U.S. Cl. CPC H04L 63/1441; H04L 63/20; H04L 63/1416

(57) ABSTRACT

A test device stores and runs a test container, and the test container includes a plurality of cyberattack tools. The test device receives a user command from a user. During the runtime of the test container, the test device analyzes the user command to launch a test of cyberattack, such that the cyber defense mechanism of the device under test is tested.

### PRIORITY

This application claims priority to Taiwan Patent Application No. 109100076 filed on Jan. 2, 2020, which is hereby incorporated by reference in its entirety.

### FIELD

The present disclosure relates to a device, a method and a non-transitory tangible machine-readable medium for testing a cyber defense mechanism of a device under test. More particularly, the present disclosure relates to a device, a method, and a non-transitory tangible machine-readable medium for testing the cyber defense mechanism through cyberattacks.

### BACKGROUND

In the conventional test modes that are based on cyberattacks (i.e., tests of cyberattack), a tester may check the completeness of the cyber defense mechanism of a device under test by performing cyberattacks to the device under test. Said cyber defense mechanism may refer to one or more software, firmware, or hardware adopted by the device under test so as to prevent from and/or resist cyberattacks. Various cyberattack tools such as “hping3”, “HULK”, “Saddam” or the like may be configured to test the cyber defense mechanism, and each of them comprise at least one cyberattack pattern (e.g., SYN packet flood, user datagram protocol (UDP) packet flood, transmission control protocol (TCP) packet flood, internet control message protocol (ICMP) packet flood etc.) Practically, multiple cyberattack tools may be used to perform a complex test to the device under test in order to obtain a more comprehensive test result. Under such circumstances, since there is a corresponding call command for each cyberattack tool, the tester must install the required cyberattack tools individually on the test device, therefore making the pre-operations of the test quite time-consuming.

Aside from that, in conventional test modes based on cyberattacks, when a user (i.e., the tester) wants to perform a specific cyberattack pattern among the aforementioned cyberattack patterns to the device under test, he/she has to provide commands related to the specific cyberattack pattern for a plurality of cyberattack tools because there could be multiple cyberattack tools corresponding to the specific cyberattack pattern (the commands accepted by the cyberattack tools may correspond to different programming languages). Moreover, the user has to switch among the cyberattack tools iteratively so as to reach an ideal test efficacy, therefore making the test processes very complicated to the user.

Moreover, in view of the fact that the above cyberattack patterns are mostly distributed cyberattacks (or the patterns of distributed cyberattacks are required in order to achieve the best test results), the test device requires multiple subordinate (or “slave”) test devices (e.g., multiple zombie devices that have been successfully compromised) to thoroughly complete the test. In this case, in addition to the above-mentioned time-consuming cyberattack-tool-installation process on the test device, the user must also perform the above-mentioned process on each subordinate test device, which makes the required time of the pre-operations that are already time-consuming grow in multiples, not to mention that such subordinate test devices may run more than one operating system, resulting in the uncertainty of whether each required cyberattack tool can be successfully installed on each subordinate test device. Accordingly, it is essential to provide a test mode that is easy to be applied on the test device and the subordinate test devices, and convenient for users to provide commands to various cyberattack tools.

### SUMMARY

The disclosure provides a test device for testing a cyber defense mechanism of a device under test. The test device may comprise a storage, a transceiver and a processor electrically connected with the storage and the transceiver. The storage may be configured to store a test container, and the test container may comprise a plurality of cyberattack tools. The transceiver may be configured to receive a user command from a user. The processor may be configured to execute the test container and analyze, during the runtime of the test container, the user command so as to launch a test of cyberattack to the device under test according to the user command and via the transceiver, such that the cyber defense mechanism of the device under test is tested. The test of cyberattack corresponds to at least two of the cyberattack tools.

The disclosure also provides a test method for testing a cyber defense mechanism of a device under test. The test method may comprise:
receiving, by a test device, a user command from a user;
executing, by the test device, a test container, wherein the test container comprises a plurality of cyberattack tools; and
analyzing, by the test device during the runtime of the test container, the user command so as to launch a test of cyberattack to the device under test according to the user command and via the transceiver, such that the cyber defense mechanism of the device under test is tested, wherein the test of cyberattack corresponds to at least two of the cyberattack tools.

The disclosure further provides a non-transitory tangible machine-readable medium. The non-transitory tangible machine-readable medium may be stored within a computer program. The computer program may comprise a plurality of codes, the plurality of codes being configured to execute a test method when the computer program is loaded into a test device. The test method may comprise:
receiving a user command from a user;
executing a test container, wherein the test container comprises a plurality of cyberattack tools; and
analyzing, during the runtime of the test container, the user command so as to launch a test of cyberattack to the device under test according to the user command and via the transceiver, such that the cyber defense mechanism of the device under test is tested, wherein the test of cyberattack corresponds to at least two of the cyberattack tools.

The test container comprises the cyberattack tools, and the test device executes/runs the test container, so that the user only needs to provide instructions that are acceptable to the test container to the test device in order to launch a test of cyberattack corresponding to more than one cyberattack tool. In addition, through the test container, the deployment of subordinate test devices is more versatile and time-saving. Therefore, compared with the traditional cyberattack-based test mode, users may test the cyber defense mechanism by using the test device in this disclosure more quickly and conveniently.

The aforesaid content is not intended to limit the present invention, but merely describes the technical problems that can be solved by the present invention, the technical means that can be adopted, and the technical effects that can be achieved, so that people having ordinary skill in the art can basically understand the present invention. People having ordinary skill in the art can understand the various embodiments of the present invention according to the attached figures and the content recited in the following embodiments.

### BRIEF DESCRIPTION OF THE DRAWINGS

The drawings are provided for describing various embodiments, in which:

FIG. 1A illustrates a test system test data according to one or more embodiments of the present invention;

FIG. 1B illustrates another one or more embodiments of the test system shown in FIG. 1A;

FIG. 2 illustrates the software hierarchy diagram of a test container according to one or more embodiments of the present invention;

FIG. 3 illustrates a test method according to one or more embodiments of the present invention.

### DETAILED DESCRIPTION

The exemplary embodiments described below are not intended to limit the present invention to any specific environment, applications, structures, embodiments, examples, processes or steps as described in these example embodiments. In the attached figures, elements not directly related to the present invention are omitted from depiction. In the attached figures, dimensional relationships among individual elements in the attached drawings are merely examples but not to limit the actual scale. Unless otherwise described, the same (or similar) element symbols may correspond to the same (or similar) elements in the following description. Unless otherwise described, the number of each element described below may be one or more under implementable circumstances.

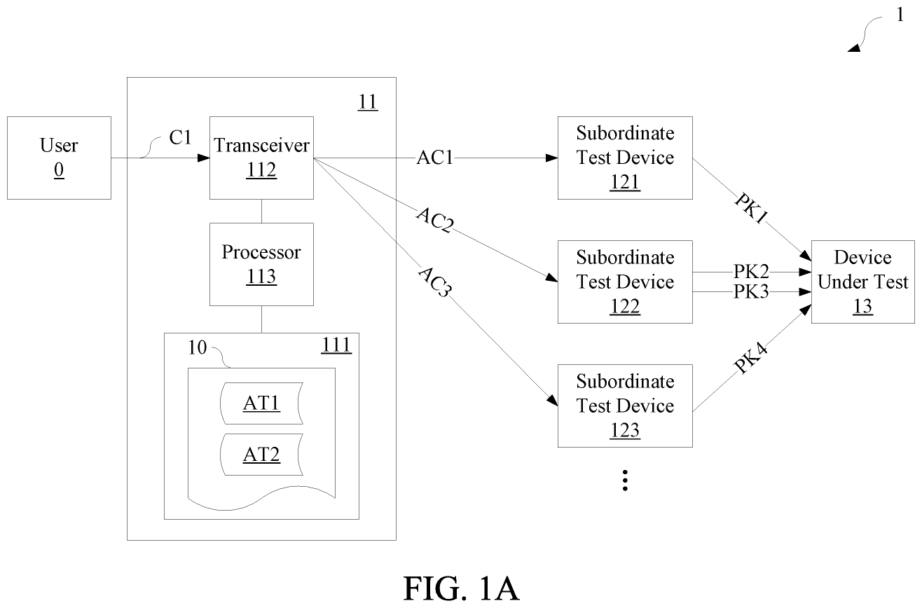

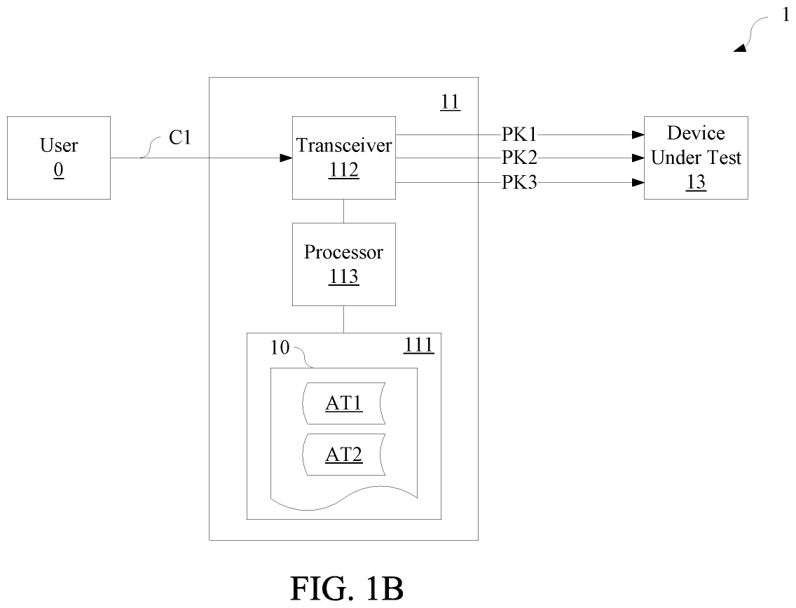

Referring to FIG. 1A, a test system 1 may comprise a test device 11, a plurality of subordinate test devices 121, 122, 123, . . . , and a device under test (hereinafter referred to as “DUT”) 13. The test device 11 may communicate with a user 0 and the subordinate test devices 121, 122, 123, . . . , and launch a test of cyberattack to the DUT 13 according to a user command C1 provided by the user 0. Specifically, in some embodiments, the test device 11 and the subordinate test devices 121, 122, 123, . . . may form a master-slave architecture, and the test device 11 may perform the test of cyberattack to the DUT 13 via the subordinate test devices 121, 122, 123, . . . , in order to test the cyber defense mechanism of the DUT 13. The test device 11 may generally comprise a storage 111, a transceiver 112 and a processor 113 electrically connected with the storage 111 and the transceiver 112.

The transceiver 112 may be configured to communicate with the DUT, the user 0 (in some embodiments, the user 0 may refer to an electronic device operated by a user and having a communication function) and the subordinate test devices 121, 122, 123, . . . in a wired or a wireless manner, and may comprise a transmitter and a receiver. Taking wireless communication for example, the transceiver 112 may comprise for example but not limited to communication elements such as an antenna, an amplifier, a modulator, a demodulator, a detector, an analog-to-digital converter, a digital-to-analog converter or the like. Taking wired communication for example, the transceiver 112 may be, but not limited to, a gigabit Ethernet transceiver, a gigabit interface converter (GBIC), a small form-factor pluggable (SFP) transceiver [symbol] a ten gigabit small form-factor pluggable (XFP) transceiver, or the like.

The storage 111 may be configured to store the data produced by the test device 11 or received from the outside of the test device 11. The storage 111 may comprise a first-level memory (also referred to as main memory or internal memory), and the processor 113 may directly read the instruction set stored in the first-level memory and execute the instruction sets as needed. The storage 111 may optionally comprise a second-level memory (also referred to as an external memory or a secondary memory), and the second-level memory may transmit the stored data to the first-level memory through the data buffer. For example, the second-level memory may be, but not limited to, a hard disk, a compact disk, or the like. The storage 111 may optionally comprise a third-level memory, that is, a storage device that may be directly inserted or removed from a computer, such as a portable hard disk. In some embodiments, the storage 111 may optionally comprise a cloud storage unit.

For example, the storage 111 may store a test container 10. The test container 10 may be a software entity based on the techniques of virtual containers, and may comprise a plurality of cyberattack tools AT1, AT2, . . . . The test container 10 may integrate the respective parameters and functions of the cyberattack tools AT1, AT2, . . . , and provide an application programming interface (API) to allow the user 0 to call each of the cyberattack tools to transmit malicious packets with a single programming language command, instead of calling each cyberattack tool individually with its own command. In some embodiments, the malicious packets may refer to packets that cause an abnormal state of the receiver, such as a crash, exhaustion of resources, incorrect behavior, involuntary shutdown, or the like. In some embodiments, the cyberattack tools AT1, AT2, . . . may be the cyberattack tools such as, but not limited to, the aforementioned “hping3”, “HULK”, and “Saddam”.

The processor 113 may be a microprocessor or a microcontroller having a signal processing function. A microprocessor or microcontroller is a programmable special integrated circuit that has the functions of operation, storage, output/input, etc., and can accept and process various coding instructions, thereby performing various logic operations and arithmetic operations, and outputting the corresponding operation result. The processor 113 may be programmed to execute various operations or programs in the test device 11.

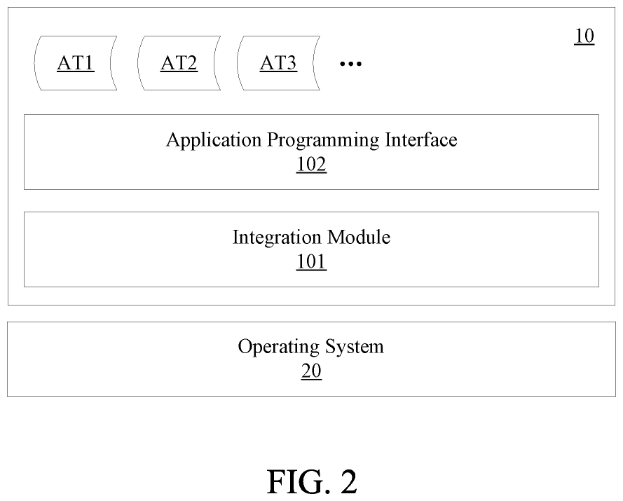

In some embodiments, the processor 113 may be used to generate the test container 10 before performing the test. Specifically, as shown in FIG. 1A and FIG. 2, in addition to the operating system layer virtualization (i.e., containerization) steps that must be performed to generate a container, the processor 113 may first trigger each of the cyberattack tools AT1, AT2, AT3 . . . to generate its packet. Accordingly, the processor 113 may summarize at least one cyberattack pattern corresponding to each of the cyberattack tools by analyzing the packets (e.g., analyzing the information such as the Internet protocol, packet format, service content, transmission rate, number of packets, and/or the header format used by the packets). In some embodiments, the cyberattack pattern may be at least the foregoing multiple denial-of-service (DoS) attacks.

After obtaining the correspondence between each of the cyberattack tools and the cyberattack pattern, the processor 113 may determine a plurality of instructions of calling each of the cyberattack tools based on the cyberattack pattern, and then generates a corresponding call command set for the summarized cyberattack pattern. After the call command set is generated, the processor 113 may establish an application programming interface 102 based on the call command set, thereby enabling the test container 10 to have the foregoing feature that allows the user 0 to call each cyberattack tool through a single programming language.

For example, it is assumed that the cyberattack patterns corresponding to the cyberattack tools AT1, AT2, and AT3 comprise a first pattern (e.g., SYN packet flood), a second pattern (e.g., domain name system (DNS) packet flood), a third pattern (e.g., UDP packet flood), and a fourth pattern (e.g., TCP packet flood), and the cyberattack tool AT1 corresponds to the first pattern and the second pattern, the cyberattack tool AT2 corresponds to the third pattern and the fourth pattern, and the cyberattack tool AT3 corresponds to the second pattern and the third pattern. Meanwhile, the call command set may comprise at least the commands such as “-A SYN flood”, “-B DNS flood”, “-C UDP flood”, and “-D TCP flood”, and the relationship between the commands and the called cyberattack tool(s) may be shown in Table 1 below:

TABLE 1

| Command | Cyberattack tool(s) to be called |
|---|---|
| A SYN flood | cyberattack tool AT1 |
| B DNS flood | cyberattack tool AT1, AT3 |
| C UDP flood | cyberattack tool AT2, AT3 |
| D TCP flood | cyberattack tool AT2 |

In some embodiments, each step of the processor 113 establishing the test container 10 may be integrated into an integration module 101, which is used to integrate the cyberattack tools AT1, AT2, AT3, . . . stored in the storage 111, and to create or update the application programming interface 102 and the corresponding call command set.

In some embodiments, the processor 113 may further learn the packet format of each of the cyberattack tools through a machine learning algorithm to summarize the corresponding cyberattack pattern in more detail.

In some embodiments, as shown in FIG. 2, since the test container 10 is a software entity based on the virtual container technology, even if multiple devices are running different operating systems 20 (e.g., Microsoft Windows, Linux, Apple MacOS/OSX, etc.), as long as its operating system 20 supports virtual container technology, the test container 10 can be run on the device. In view of this, the processor 113 may deploy the test container 10 to each of the subordinate test devices 121, 122, 123, . . . through the transceiver 112, so that each of the subordinate test devices runs the test container 10. In these embodiments, optionally, the test container 10 of the test device 11 may comprise a node management module, and each test container 10 of the subordinate test device may comprise an agent module. The agent module is used to communicate with the node management module, and the node management module is used to manage and control each of the subordinate test devices that comprises the agent module. In these embodiments, optionally, the test container 10 of the test device 11 may further comprise a web interface for interacting with the node management module, and the user 0 may enter the user command C1 through the web interface, or manage each subordinate test device.

When the test device 11 starts a test, the processor 113 may be used to run the test container 10. While the test container 10 is running, the processor 113 may analyze the user command C1 received by the transceiver 112 through the application programming interface 102 and the call command set. The user 0 can specify the test target and the test pattern to be performed on the test device 11 by providing the user command C1 included in the call command set of the test container 10. Therefore, in some embodiments, the user command C1 may comprise at least a network address of the test target and a cyberattack pattern (e.g., SYN packet flood, UDP packet flood or the like). In some embodiments, the user command C1 may further comprise other information such as the start time of the test, the end time of the test, the duration of the test, and/or a specified cyberattack tool.

After analyzing the user command C1, the processor 113 may know what type of cyberattack the user 0 wants to perform. Accordingly, the processor 113 may launch a corresponding test of cyberattack to the DUT 13 through the transceiver 112 according to the user command C1, and then test the cyber defense mechanism of the DUT 13. Specifically, since the user 0 has specified a specific cyberattack pattern, the processor 113 may use at least two of the cyberattack tools AT1, AT2, . . . to launch the test of cyberattack that matches the specific cyberattack pattern.

In some embodiments, as shown in FIG. 1A and Table 1 above, the processor 113 may determine how to use the subordinate test devices 121, 122, 123, . . . to perform the cyberattack according to the user command C1, and therefore may generate a test strategy. For example, suppose that user 0 specified the SYN packet flood for testing through the user command C1 of “-A SYN flood”, the test strategy may be assigning the subordinate test device 121 to execute the functions related to the SYN packet flood in “hping3”, assigning the subordinate test device 122 to execute the functions related to the SYN packet flood in “Saddam”, and assigning the subordinate test device 123 to execute the functions related to the SYN packet flood in “HULK”, etc. For another example, the test strategy may otherwise be assigning each of the subordinate test devices 121, 122, 123, . . . to respectively execute the functions related to the SYN packet flood in “hping3” and “HULK” in sequence.

After obtaining the test strategy, the processor 113 may generate a plurality of attack commands AC1, AC2, AC3, . . . , and transmit the attack commands to the subordinate test devices 121, 122, 123, . . . through the transceiver 112 accordingly, so as to assign the tasks of each subordinate test device. Since the subordinate test devices 121, 122, 123, . . . also run the test container 10, they may share the same command set with the test device 11. For example, the attack command AC1 sent to the subordinate test device 121 may be “-A SYN flood -tool -b” to assign the subordinate test device 121 to execute the functions related to the SYN packet flood in a cyberattack tool numbered “b” (e.g., “HULK”). After receiving the attack commands AC1, AC2, AC3, . . . , the subordinate test devices 121, 122, 123, . . . may generate a plurality of malicious packets PK1, PK2, PK3, PK4, . . . according to their respective attack commands, and transmit the malicious packets to the DUT 13.

As shown in FIG. 1B, in some embodiments, the processor 113 may directly generate the malicious packets PK1, PK2, PK3, . . . according to the user command C1, and directly transmit the malicious packets to the DUT 13 through the transceiver 112. In other words, the test device 11 may be used to directly test the DUT 13 without the subordinate test devices 121, 122, 123, . . . , that is, under the premise that the computational performance of the test device 11 is sufficiently powerful, the test device 11 may independently launch a test of cyberattack that is equivalent to a distributed denial-of-service (DDoS) attack.

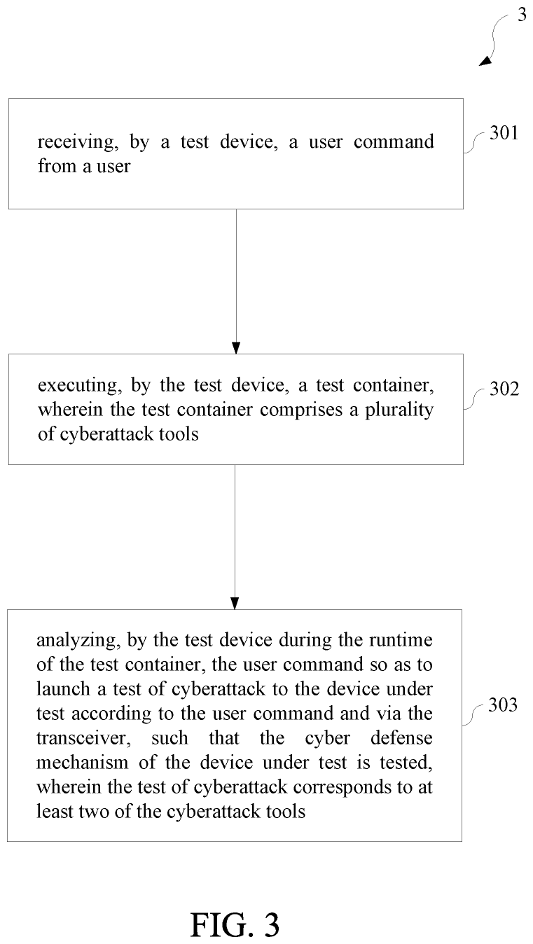

Referring to FIG. 3, a test method 3 for testing a cyber defense mechanism of a device under test according to one or more embodiments of the present invention may comprise the following steps:
receiving, by a test device, a user command from a user (marked as 301);
executing, by the test device, a test container, wherein the test container comprises a plurality of cyberattack tools (marked as 302); and
analyzing, by the test device during the runtime of the test container, the user command so as to launch a test of cyberattack to the device under test according to the user command and via the transceiver, such that the cyber defense mechanism of the device under test is tested, wherein the test of cyberattack corresponds to at least two of the cyberattack tools (marked as 303).

In some embodiments, the test method 3 may further comprise the following steps:
generating, by the test device, a plurality of malicious packets according to the user command; and
transmitting, by the test device, the malicious packets to the device under test, such that the test of cyberattack is completed, wherein the malicious packets correspond to at least two of the cyberattack tools.

In some embodiments, the test method 3 may further comprise the following steps:
generating, by the test device, a plurality of attacking commands for a plurality of subordinate test devices according to the user command, wherein each of the subordinate test devices stores and executes the test container; and
transmitting, by the test device, the attacking commands to the subordinate test devices so that the subordinate test devices generate a plurality of malicious packets according to the attacking commands and transmit the malicious packets to the device under test, therefore completing the test of cyberattack, wherein the malicious packets correspond to at least two of the cyberattack tools. In these embodiments, optionally, the test method 3 may further comprise the following step: deploying, by the test device, the test container to each of the subordinate test devices.

In some embodiments, the test method 3 may further comprise the following steps:
triggering, by the test device, the cyberattack tools to obtain at least one packet generated by each of the cyberattack tools;
analyzing, by the test device, the packets to summarize at least one cyberattack pattern corresponding to each of the cyberattack tools, wherein the test of cyberattack corresponds to one of the cyberattack patterns;
generating, by the test device, a call command set corresponding to the cyberattack patterns, wherein the call command set comprises the user command; and
providing, by the test device, an application programming interface based on the call command set, so as to establish the test container.

In some embodiments, regarding the test method 3, the user command corresponds to an application programming interface of the test container, and the user command at least comprises a target internet protocol address for testing and a cyberattack pattern.

In some embodiments, the test method 3 may further comprise the following steps:
generating, by the test device, a plurality of attacking commands for a plurality of subordinate test devices according to the user command, wherein each of the subordinate test devices stores and executes the test container; and
transmitting, by the test device, the attacking commands to the subordinate test devices so that the subordinate test devices generate a plurality of malicious packets according to the attacking commands and transmit the malicious packets to the device under test, therefore completing the test of cyberattack, wherein the malicious packets correspond to at least two of the cyberattack tools.

In addition to the aforesaid embodiments, there are other embodiments of the test method 3 which correspond to those of the test device 11. These embodiments of the test method 3 which are not mentioned specifically can be directly understood by people having ordinary skill in the art based on the aforesaid descriptions for the test device 11, and will not be further described herein.

Aside from that, the test method 3 may further be implemented as a computer program comprising a plurality of codes. The codes are able to execute the test method 3 when the computer program is loaded into an electronic apparatus. The computer program may be stored in a non-transitory tangible machine-readable medium, for example but not limited to: a read-only memory (ROM), a flash memory, a floppy disk, a mobile hard disk, a magnetic tape, a database accessible to networks, or any other storage medium with the same function and well known to the people having ordinary skill in the art.

The above disclosure is related to the detailed technical contents and inventive features thereof. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A test device for testing a cyber defense mechanism of a device under test, comprising:
a storage, configured to store a test container, wherein the test container comprises a plurality of cyberattack tools;
a transceiver, configured to receive a user command from a user; and
a processor, electrically connected with the storage and the transceiver, configured to:
execute the test container; and
analyze, during the runtime of the test container, the user command so as to launch a test of cyberattack to the device under test according to the user command and via the transceiver, such that the cyber defense mechanism of the device under test is tested, wherein the test of cyberattack corresponds to at least two of the cyberattack tools.

2. The test device of claim 1, wherein:
the processor is further configured to generate a plurality of malicious packets according to the user command; and
the transceiver is further configured to transmit the malicious packets to the device under test, such that the test of cyberattack is completed, wherein the malicious packets correspond to at least two of the cyberattack tools.

3. The test device of claim 1, wherein:
the processor is further configured to generate a plurality of attacking commands for a plurality of subordinate test devices according to the user command, wherein each of the subordinate test devices stores and executes the test container; and
the transceiver is further configured to transmit the attacking commands to the subordinate test devices so that the subordinate test devices generate a plurality of malicious packets according to the attacking commands and transmit the malicious packets to the device under test, therefore completing the test of cyberattack, wherein the malicious packets correspond to at least two of the cyberattack tools.

4. The test device of claim 1, wherein the processor is further configured to:
trigger the cyberattack tools to obtain at least one packet generated by each of the cyberattack tools;
analyze the packets to summarize at least one cyberattack pattern corresponding to each of the cyberattack tools, wherein the test of cyberattack corresponds to one of the cyberattack patterns;
generate a call command set corresponding to the cyberattack patterns, wherein the call command set comprises the user command; and
provide an application programming interface based on the call command set, so as to establish the test container.

5. The test device of claim 1, wherein the user command corresponds to an application programming interface of the test container, and the user command at least comprises a target internet protocol address for testing and a cyberattack pattern.

6. The test device of claim 3, wherein the transceiver is further configured to deploy the test container to each of the subordinate test devices.

7. A test method for testing a cyber defense mechanism of a device under test, comprising:
receiving, by a test device, a user command from a user;
executing, by the test device, a test container, wherein the test container comprises a plurality of cyberattack tools; and
analyzing, by the test device during the runtime of the test container, the user command so as to launch a test of cyberattack to the device under test according to the user command and via the transceiver, such that the cyber defense mechanism of the device under test is tested, wherein the test of cyberattack corresponds to at least two of the cyberattack tools.

8. The test method of claim 7, further comprising:
generating, by the test device, a plurality of malicious packets according to the user command; and
transmitting, by the test device, the malicious packets to the device under test, such that the test of cyberattack is completed, wherein the malicious packets correspond to at least two of the cyberattack tools.

9. The test method of claim 7, further comprising:
generating, by the test device, a plurality of attacking commands for a plurality of subordinate test devices according to the user command, wherein each of the subordinate test devices stores and executes the test container; and
transmitting, by the test device, the attacking commands to the subordinate test devices so that the subordinate test devices generate a plurality of malicious packets according to the attacking commands and transmit the malicious packets to the device under test, therefore completing the test of cyberattack, wherein the malicious packets correspond to at least two of the cyberattack tools.

10. The test method of claim 7, further comprising:
triggering, by the test device, the cyberattack tools to obtain at least one packet generated by each of the cyberattack tools;
analyzing, by the test device, the packets to summarize at least one cyberattack pattern corresponding to each of the cyberattack tools, wherein the test of cyberattack corresponds to one of the cyberattack patterns;
generating, by the test device, a call command set corresponding to the cyberattack patterns, wherein the call command set comprises the user command; and
providing, by the test device, an application programming interface based on the call command set, so as to establish the test container.

11. The test method of claim 7, wherein the user command corresponds to an application programming interface of the test container, and the user command at least comprises a target internet protocol address for testing and a cyberattack pattern.

12. The test method of claim 9, further comprising:
deploying, by the test device, the test container to each of the subordinate test devices.

13. A non-transitory tangible machine-readable medium, wherein a test device executes a test method by executing a plurality of program instructions comprised in the non-transitory tangible machine-readable medium when the non-transitory tangible machine-readable medium is loaded to the test device, the test method comprising:
receiving a user command from a user;
executing a test container, wherein the test container comprises a plurality of cyberattack tools; and
analyzing, during the runtime of the test container, the user command so as to launch a test of cyberattack to the device under test according to the user command and via the transceiver, such that the cyber defense mechanism of the device under test is tested, wherein the test of cyberattack corresponds to at least two of the cyberattack tools.

14. The non-transitory tangible machine-readable medium of claim 13, wherein the test method further comprises:
generating a plurality of malicious packets according to the user command; and
transmitting the malicious packets to the device under test, such that the test of cyberattack is completed, wherein the malicious packets correspond to at least two of the cyberattack tools.

15. The non-transitory tangible machine-readable medium of claim 13, wherein the test method further comprises:
generating a plurality of attacking commands for a plurality of subordinate test devices according to the user command, wherein each of the subordinate test devices stores and executes the test container; and
transmitting the attacking commands to the subordinate test devices so that the subordinate test devices generate a plurality of malicious packets according to the attacking commands and transmit the malicious packets to the device under test, therefore completing the test of cyberattack, wherein the malicious packets correspond to at least two of the cyberattack tools.

16. The non-transitory tangible machine-readable medium of claim 13, wherein the test method further comprises:
triggering the cyberattack tools to obtain at least one packet generated by each of the cyberattack tools;
analyzing the packets to summarize at least one cyberattack pattern corresponding to each of the cyberattack tools, wherein the test of cyberattack corresponds to one of the cyberattack patterns;
generating a call command set corresponding to the cyberattack patterns, wherein the call command set comprises the user command; and
providing an application programming interface based on the call command set, so as to establish the test container.

17. The non-transitory tangible machine-readable medium of claim 13, wherein the user command corresponds to an application programming interface of the test container, and the user command at least comprises a target internet protocol address for testing and a cyberattack pattern.

18. The non-transitory tangible machine-readable medium of claim 15, wherein the test method further comprises:
deploying the test container to each of the subordinate test devices.
